(19) United States
(12) Patent Application Publication
(10) Pub. No.: US 2011/0111119 A1
(43) Pub. Date: May 12, 2011

(54) METHOD OF MANUFACTURING SHEET TYPE ELECTRONIC PAPER DISPLAY DEVICE

(75) Inventors: Sang Jin KIM, Suwon (KR); Yongsoo Oh, Seongnam (KR); Hwan-Soo Lee, Seoul (KR); Sang Moon Lee, Seoul (KR); Young Woo Lee, Suwon (KR)

(73) Assignee: SAMSUNG ELECTRO-MECHANICS CO., LTD., Suwon (KR)

(21) Appl. No.: 12/763,065

(22) Filed: Apr. 19, 2010

(30) Foreign Application Priority Data
Nov. 12, 2009 (KR) 10-2009-0109095

(51) Int. Cl. B41M 5/40

(52) U.S. Cl. 427/146

(57) ABSTRACT

There is provided a method of manufacturing a sheet type electronic paper display device. The method includes: forming a preliminary substrate including a plurality of raised patterns having a greater width than a diameter of first rotary bodies, and a plurality of cell spaces formed between the raised patterns; disposing second rotary bodies in the plurality of cell spaces; injecting a first elastomer matrix into the cell spaces to cover the second rotary bodies; separating the first elastomer matrix from the preliminary substrate to thereby obtain a semi-sheet type structure including depressed patterns corresponding to the raised patterns, protrusions corresponding to the cell spaces and formed of the first elastomer matrix, and the second rotary bodies located within the protrusions; disposing the first rotary bodies in the depressed patterns; and injecting a second elastomer matrix into the depressed patterns to cover the first rotary bodies.

### CROSS-REFERENCE TO RELATED APPLICATIONS

This application claims the priority of Korean Patent Application No. 10-2009-0109095 filed on Nov. 12, 2009, in the Korean Intellectual Property Office, the disclosure of which is incorporated herein by reference.

### BACKGROUND OF THE INVENTION

1. Field of the Invention

The present invention relates to a method of manufacturing an electronic paper display device having a sheet shape, and more particularly, to a method of manufacturing sheet type electronic paper display device capable of realizing a high contrast ratio and low driving voltage.

2. Description of the Related Art

A shift in information exchange and sharing methods is currently in demand, corresponding to modern society's requirement for a new information delivery paradigm. To meet this demand, the development of technologies associated with flexible electronic paper has recently been accelerated and are now entering the phase of commercial development.

Compared with existing flat display panels, an electronic paper display requires relatively low manufacturing costs, and is far superior in terms of energy efficiency, since it is operable even with a very low level of energy due to the needlessness of backlighting or continuous recharge. Furthermore, electronic paper enables a high definition display, provides a wide viewing angle, and is equipped with a memory function that retains the display of letters (characters) even when unpowered. The above-described advantages make electronic paper applicable in a wide variety of technical fields, such as electronic books having paper-like sheets and moving illustrations, self-updating newspapers, reusable paper displays for mobile phones, disposable TV screens, and electronic wallpaper. There is a massive potential market for such electronic paper.

A technical approach for the implementation of electronic paper may be roughly divided into four methods: a twist-ball method, an electrophoretic method, a quick response-liquid power display (QR-LPD) method, and a cholesteric liquid crystal display method. Here, the twist ball method involves rotating spherical particles, each having upper and lower hemispheres having opposite electrical charges and different colors, by using an electric field. As for the electrophoretic method, colored charged particles mixed with oil are trapped in micro-capsules or micro-cups, or charged particles are made to respond to the application of an electric field. The QR-LPD method uses charged powder. The cholesteric liquid crystal display method uses the selective reflection of cholesteric liquid crystal molecules.

As for the twist-ball method, cells are filled with a transparent medium, and twist balls, each having opposite electrical charges and colored with different colors, for example black and white, are disposed in the transparent medium. Each twist ball, when receiving voltage, rotates such that the part of its body having an opposite polarity to the received electric charge faces the front. In such a manner, black and white are displayed.

In general, the twist balls are arrayed by a casting method. However, the arrangement of the twist balls is not uniform, and a high voltage is required in driving the twist balls.

### SUMMARY OF THE INVENTION

An aspect of the present invention provides a method of manufacturing an electronic paper display device having a sheet shape, capable of realizing a high contrast ratio and low driving voltage.

According to an aspect of the present invention, there is provided a method of manufacturing a sheet type electronic paper display device, the method including: forming a preliminary substrate including a plurality of raised patterns having a greater width than a diameter of first rotary bodies, and a plurality of cell spaces formed between the raised patterns; disposing second rotary bodies in the plurality of cell spaces; injecting a first elastomer matrix into the cell spaces to cover the second rotary bodies; separating the first elastomer matrix from the preliminary substrate to thereby obtain a semi-sheet type structure including depressed patterns corresponding to the raised patterns, protrusions corresponding to the cell spaces and formed of the first elastomer matrix, and the second rotary bodies located within the protrusions; disposing the first rotary bodies in the depressed patterns; and injecting a second elastomer matrix into the depressed patterns to cover the first rotary bodies.

The raised patterns may have a greater height than a diameter of the second rotary bodies by 50 μm to 80 μm.

The first rotary bodies and the second rotary bodies may have the same diameter.

The raised patterns may have a smaller height than a diameter of the second rotary bodies.

The first rotary bodies may have a smaller diameter than the second rotary bodies.

The preliminary substrate may be formed by an imprinting process, a laser patterning process, a photolithography process or an etching process.

The first and second rotary bodies may have two display regions colored with different colors and having different electrical charge properties.

The first rotary bodies and the second rotary bodies may have a spherical, oval or cylindrical shape.

The first elastomer matrix and the second elastomer matrix may be at least one selected from the group consisting of polyethylene terephthalate (PET), polycarbonate (PC), poly(methyl methacrylate) (PMMA), polyethylene naphthalate (PEN), polyethersulfone (PES), cyclic olefin copolymer (COC), polydimethylsiloxane (PDMS), and polyurethane acrylate (PUA).

### BRIEF DESCRIPTION OF THE DRAWINGS

The above and other aspects, features and other advantages of the present invention will be more clearly understood from the following detailed description taken in conjunction with the accompanying drawings, in which:

FIG. 1A and FIGS. 2 through 7 are cross-sectional views illustrating the process of manufacturing an electronic paper display device according to an exemplary embodiment of the present invention; and

FIG. 1B is an enlarged perspective view illustrating a rotary body according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity. Like reference numerals in the drawings denote like elements.

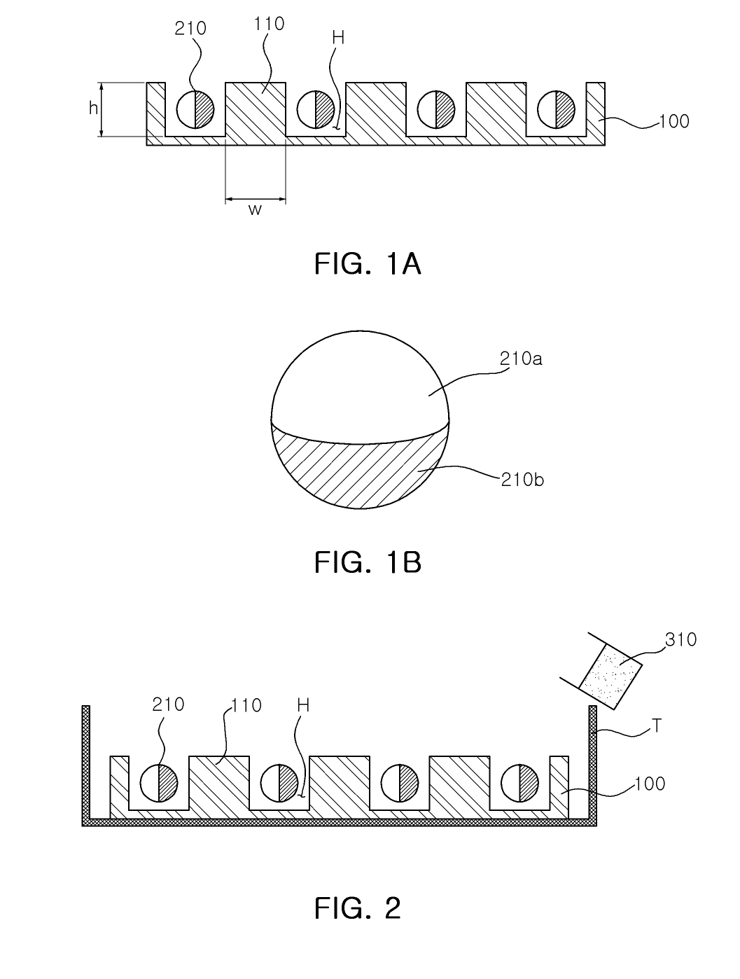

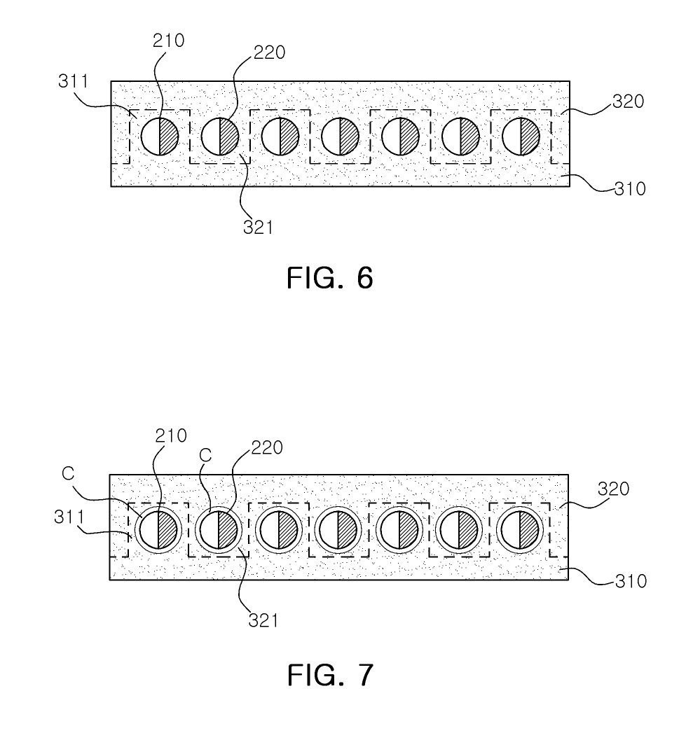

FIG. 1A and FIGS. 2 through 7 are cross-sectional views illustrating the process of manufacturing an electronic paper display device according to an exemplary embodiment of the present invention. FIG. 1B is an enlarged perspective view illustrating a rotary body according to an exemplary embodiment of the present invention.

First, as shown in FIG. 1A, a preliminary substrate 100 having a plurality of raised patterns 110 is prepared. The preliminary substrate 100 has a plurality of cell spaces H due to the plurality of raised patterns 110.

The preliminary substrate 100 may be formed of a material having a high release property with respect to an elastomer matrix. The preliminary substrate 100 may be formed of, for example, silicon, resin or the like, but is not limited thereto.

A structure with a predetermined thickness is formed using silicon or resin. Thereafter, raised patterns may be formed on this structure by using imprinting, laser patterning, photolithography, etching or the like.

In greater detail, a resin layer with a predetermined thickness is formed and then pressed with a stamp having raised and depressed patterns. In such a manner, the preliminary substrate, having raised patterns and cell spaces corresponding to the raised and depressed patterns of the stamp, may be formed. In this case, the width and height of each raised pattern of the preliminary substrate, the intervals between the patterns and the shape and size of each cell space may be controlled by adjusting the raised and depressed patterns of the stamp.

The raised patterns 110 are used to form the depressed patterns of a semi-sheet type structure to be described later. First rotary bodies are disposed in the respective depressed patterns of the semi-sheet type structure. In this regard, the width of each raised pattern is set to be greater than the diameter of the first rotary body.

The height h of the raised patterns 110 may be greater than the diameter of second rotary bodies 210. The raised patterns 110 form the depressed patterns in which the first rotary bodies are disposed in the following process. When the height h of the raised patterns 110 is similar to the diameter of the second rotary bodies 210, the first rotary bodies having the same diameter as that of the second rotary bodies 210 may be disposed in the depressed patterns. Accordingly, an electronic paper sheet having a monolayer structure may be manufactured. Here, in the monolayer structure, the centers of the first rotary bodies are placed collinearly with the centers of the second rotary bodies. In due consideration of areas for the formation of cavities surrounding the first rotary bodies and the second rotary bodies, the height h of the raised patterns may be greater than the diameter of the second rotary bodies by approximately 50 μm to 80 μm.

Alternatively, although not shown, the height h of the raised patterns 110 may be smaller than the diameter of the second rotary bodies 210. In this case, first rotary bodies, having a smaller diameter than the second rotary bodies 210, may be disposed therein. The first rotary bodies and the second rotary bodies may be disposed collinearly, even if their centers are not placed collinearly.

Thereafter, the second rotary bodies 210 are disposed in the plurality of cell spaces H formed in the preliminary substrate 100. Here, the second rotary bodies 210 have electrical and optical anisotropy.

The second rotary bodies 210 may be disposed in the cell spaces H by using a squeegee or the like. In greater detail, a mask or a filter exposing only the cell spaces is disposed and the second rotary bodies 210 may be then disposed by using a squeegee or the like.

FIG. 1B is an enlarged schematic perspective view illustrating the second rotary body 210. Referring to FIG. 1B, the rotary body 210 has two display regions colored with different colors and having different electrical-charge characteristics. The two display regions 210a and 210b may be colored with different colors. In detail, the first display region 210a may be colored white, while the second display region 210b may be colored black. When the first display region 210a is positively charged, the second display region 210b is negatively charged. When voltage is applied to the second rotary body 120, the second rotary body 120 is rotated according to the magnitude and direction of the voltage, so that black or white is displayed by the colors of the two display regions.

A method known in the art may be used as the method of forming the first and second display regions 120a and 120b by electrically and optically treating the rotary body 120. For example, a method of putting a rotary body into a revolving disk provided with two coloring solutions and applying centrifugal force to the rotary body may be used.

The shape of each second rotary body 210 is not limited specifically. For example, the second rotary body 210 may have a spherical, oval or cylindrical shape. The diameter of the second rotary body 120 is not limited specifically, but may range from 50 μm to 120 μm for example.

According to this exemplary embodiment, the two display regions are formed on the surface of the second rotary body 210. However, the number of display regions may be three or more as the need arises.

Further, the display regions may be colored with a variety of colors other than black or white.

For example, the first display region may be colored white or black, and the second display region 210b may be colored red, green or blue. Thus, each rotary body may display red, green or blue.

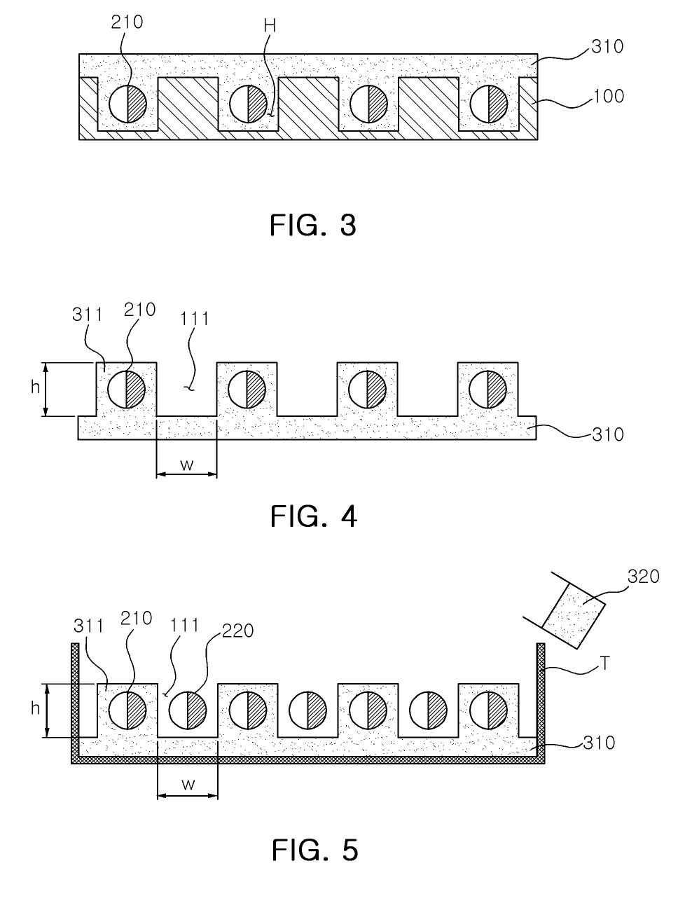

Subsequently, as shown in FIGS. 2 and 3, a first elastic matrix 310 is formed to cover the cell spaces H of the preliminary substrate 100 and the second rotary bodies 210 disposed in the cell spaces H.

The first elastomer matrix 310 may be formed of a flexible resin. The resin may be polyethylene terephthalate (PET), polycarbonate (PC), poly(methyl methacrylate) (PMMA), polyethylene naphthalate (PEN), polyethersulfone (PES), cyclic olefin copolymer (COC), polydimethylsiloxane (PDMS), and polyurethane acrylate (PUA), and a mixture of thereof. However, the resin is not limited to the description.

Here, polydimethylsiloxane (PDMS) has good adhesive properties and is thus easily adhered to and separated from a different kind of material. Therefore, the resin may preferably utilize polydimethylsiloxane (PDMS).

In greater detail, the preliminary substrate 100 is disposed in a mold T having a height which is equal to or greater than that of the raised patterns 110 of the preliminary substrate 100. Thereafter, the first elastomer matrix 310 is injected into the mold. The first elastomer matrix 310 is then cured at a predetermined temperature for a predetermined period of time. Subsequently, the mold T is removed. For example, in the case that PDMS is used for the first elastomer matrix 310, the curing process is completed after approximately 24 hours at room temperature, approximately 4 hours at a temperature of 70° C., approximately 1 hour at a temperature of 100° C., and approximately 15 minutes at a temperature of 150° C.

Thereafter, as shown in FIG. 4, once the first elastomer matrix 310 is cured, the preliminary substrate 100 and the first elastomer matrix 310 are separated from each other. The separated first elastomer matrix 310 has depressed patterns 111 corresponding to the respective raised patterns 110 of the preliminary substrate 100. Further, the first elastomer matrix 310 has protrusions 311 formed by the injection thereof into the cell spaces H of the preliminary substrate 100. The second rotary bodies 210 are placed within the protrusions 311. The first elastomer matrix 310 having the above construction will now be referred to as a semi-sheet type structure.

As for this semi-sheet type structure, the depressed patterns 111 are formed by the raised patterns 110 of the preliminary substrate 100. The width W and height h of the depressed patterns 111 correspond to the width and height of the raised patterns 110, respectively.

Subsequently, as shown in FIG. 5, first rotary bodies 220 are disposed in the depressed patterns 110. As described above, the width W of the depressed patterns 111 is greater than the diameter of the first rotary bodies 220.

The first rotary bodies 220 have the same characteristics as those of the second rotary bodies described above. However, the diameter of the first rotary bodies 220 may be different from that of the second rotary bodies.

Thereafter, a second elastomer matrix is formed in the semi-sheet type structure 310. In greater detail, the second elastomer matrix 320 is injected into the depressed patterns 111 to cover the first rotary bodies 220 disposed in the depressed patterns 111 of the semi-sheet type structure 310.

The second elastomer matrix 320 utilizes a fluent resin. The resin may utilize the same material as the first elastomer matrix 310 or a different kind of material.

The second elastomer matrix 320 may be injected by using a mold T in the same manner as the first elastomer matrix is injected. Thereafter, the second elastomer matrix 320 is cured at a predetermined temperature for a predetermined period of time. Subsequently, the mold T is removed.

The method of injecting the elastomer matrix is contributive to manufacturing an electronic paper display device that facilitates the thickness control thereof and has a small thickness. Although not limited thereto, a sheet type electronic paper display device, according to this exemplary embodiment, may have a thickness of 300 μm or less.

When the mold T is removed, the second rotary bodies 210 and the first rotary bodies 220 are densely arranged as a monolayer structure. The first rotary bodies 220 are disposed within protrusions 321 formed by the second elastomer matrix injected into the depressed patterns 111.

When the height h of the raised patterns is similar to the diameter of the second rotary bodies 210, the first rotary bodies having the same diameter as the second rotary bodies 210 may be disposed. Accordingly, an electronic paper, having a monolayer structure in which the centers of the first and second rotary bodies 210 are place collinearly, may be manufactured. This improves a contrast ratio and allows for the implementation of a small interval between electrodes, thereby requiring relatively low driving voltage.

Thereafter, as shown in FIG. 7, the first and second elastomer matrixes 310 and 320 are dipped into dielectric liquid, and an ultrasonic process is carried out, thereby forming cavities C surrounding the first and second rotary bodies 220 and 210. When the first and second elastomer matrixes 310 and 320 are dipped into dielectric liquid, the dielectric liquid permeates around the first and second rotary bodies 220 and 210 and surrounds them, to thereby form the cavities C.

Subsequently, although not shown, a first electrode may be formed on the first elastomer matrix 310, and a second electrode may be formed on the second elastomer matrix 320. The first and second electrodes may be formed of indium tin oxide (ITO) or the like.

Voltage is applied to the first and second rotary bodies 220 and 210 through the first and second electrodes, and the first and second rotary bodies 220 and 210 rotate according to the magnitude and direction of the applied voltage.

As set forth above, according to the method of manufacturing a sheet type electronic paper display device according to exemplary embodiments of the invention, rotary bodies can be densely arranged within a small thickness range. Accordingly, a contrast ratio is improved, and a small interval between electrodes can be achieved, thereby requiring relatively low driving voltage.

While the present invention has been shown and described in connection with the exemplary embodiments, it will be apparent to those skilled in the art that modifications and variations can be made without departing from the spirit and scope of the invention as defined by the appended claims.

What is claimed is:

1. A method of manufacturing a sheet type electronic paper display device, the method comprising:
forming a preliminary substrate including a plurality of raised patterns having a greater width than a diameter of first rotary bodies, and a plurality of cell spaces formed between the raised patterns;
disposing second rotary bodies in the plurality of cell spaces;
injecting a first elastomer matrix into the cell spaces to cover the second rotary bodies;
separating the first elastomer matrix from the preliminary substrate to obtain a semi-sheet type structure including depressed patterns corresponding to the raised patterns, protrusions corresponding to the cell spaces and formed of the first elastomer matrix, and the second rotary bodies located within the protrusions;
disposing the first rotary bodies in the depressed patterns; and
injecting a second elastomer matrix into the depressed patterns to cover the first rotary bodies.

2. The method of claim 1, wherein the raised patterns have a greater height than a diameter of the second rotary bodies by 50 μm to 80 μm.

3. The method of claim 1, wherein the first rotary bodies and the second rotary bodies have the same diameter.

4. The method of claim 1, wherein the raised patterns have a smaller height than a diameter of the second rotary bodies.

5. The method of claim 1, wherein the first rotary bodies have a smaller diameter than the second rotary bodies.

6. The method of claim 1, wherein the preliminary substrate is formed by an imprinting process, a laser patterning process, a photolithography process or an etching process.

7. The method of claim 1, wherein the first and second rotary bodies have two display regions colored with different colors and having different electrical charge properties.

8. The method of claim 1, wherein the first rotary bodies and the second rotary bodies have a spherical, oval or cylindrical shape.

9. The method of claim 1, wherein the first elastomer matrix and the second elastomer matrix are at least one selected from the group consisting of polyethylene terephthalate (PET), polycarbonate (PC), poly(methyl methacrylate) (PMMA), polyethylene naphthalate (PEN), polyethersulfone (PES), cyclic olefin copolymer (COC), polydimethylsiloxane (PDMS), and polyurethane acrylate (PUA).
